(19) United States
(12) Patent Application Publication
(10) Pub. No.: US 2003/0120531 A1
(43) Pub. Date: Jun. 26, 2003

(54) Employee hiring by means of a single electronic docket communicated over a network

(76) Inventor: Lloyd Parker, Sterling, VA (US)

Correspondence Address: DUANE MORRIS LLP, 100 COLLEGE ROAD WEST, SUITE 100, PRINCETON, NJ, 08540-6604, US

(21) Appl. No.: 10/247,909

(22) Filed: Sep. 20, 2002

Related U.S. Application Data
(63) Continuation-in-part of application No. 09/209,211, filed on Dec. 11, 1998.

(51) Int. Cl. G06F 17/60

(52) U.S. Cl. 705/8

(57) ABSTRACT

A method-and system for recruiting personnel include the steps of identifying potential job applicants, and setting up on a hiring network or system a single electronic docket for each candidate. By way of the network the candidate is provided with an electronic password and a job application form. The filled-out form, when used in conjunction with the password, are automatically entered into the candidate's electronic docket. A recruiting team schedules interviews, performs compensation analysis, and records interview results directly into the candidate's docket. A decision maker reviews the candidate's docket to make a hiring decision, which when entered into the network results in automatic generation of suitable messages, which are transmitted after review.

### RELATED APPLICATIONS

This application is a continuation-in-part of U.S. pat. application Ser. No. 09/209,211 filed on Dec. 11, 1998 entitled IMPROVED METHOD AND SYSTEM FOR RECRUITING PERSONNEL.

### FIELD OF THE INVENTION

This invention relates generally to methods and/or systems for the hiring of employees, and more specifically to the hiring of employees using a single electronic document over a communications network.

### BACKGROUND OF THE INVENTION

As is well known, the overall success of a company, or business entity, often revolves closely around its ability to effectively staff its programs with qualified personnel. Given recent increases in demand for technically skilled employees, for example Information Systems (IS) skilled individuals, by many competing companies, coupled with flat projections of degreed graduates has resulted in fierce competition for top candidates.

To exacerbate this situation, as companies continue to grow and develop multiple divisions, or independent business units, these independent business units compete against each other for common candidates, thus further increasing the cost of new hires.

Accordingly, there is a need for a recruiting method and system to implement it which allows for simultaneous filling of multiple positional vacancies by multiple qualified candidates without unnecessarily competing for those candidates.

By adopting the approach described in U.S. Pat. No. 09/209,211, filed Dec. 11, 1998 in the name of Williams et al., a business entity, as described therein, can reduce the overall expenditures associated with recruiting efforts by: coordinating efforts, combining resources dealing with advertising budgets, job fairs, recruiters, employment of new information technology and centralizing the recruiting effort. Williams et al. suggest that one should realize that such an approach is not merely the centralization of the recruiting function as many of the critical stages of recruitment will remain decentralized and within the control of managers.

FIGS. 1 through 13 substantially correspond to like FIGURES of the Williams et al. patent application. Referring now to the several figures, wherein like references refer to like elements, FIG. 1 illustrates the underlying concept of the above-mentioned Williams et al. patent application. By providing company hiring needs 1, preferably proactively identified, to a regional recruiting center (RRC) 5, company hiring teams can make offers using an invitational interview concept. The RRC 5 preferably provides consolidated regional resources associated with advertising, job fairs, employment agencies, IT/Internet support, contracting recruiters, college recruiting and special recruiting events.

Generally, technical recruiters associated with the RRC down-select the pool of available putative candidates (job-seekers who have not yet applied for employment with the business entity, but who may have made resumes available to the business entity), and the pool of available candidates (job seekers who have made application for a job with the business entity), and invite candidates to interview. Business unit (division for example) hiring managers interview these candidates at the RRC on predetermined days for example. Preferably, each day focuses on a particular skill set. The RRC director then coordinates collaborative roundtable sessions associated with each independent business unit's needs and the candidates who have interviewed. Pursuant to this session, select candidates are offered one salary with one or more business units.

The advantages to an approach such as that of the Williams et al. patent application include that the RRC acts essentially as a forcing function, thus shortening cycle time from recognition of a hiring need to actual hiring of an employee. Further, the controlled, integrative environment should provide each candidate with a more positive impression of the company as a whole (including each independent business unit) thus making it a more attractive employer to the candidates.

Further advantages to be realized include reducing the number of interview hours required of hiring managers, increasing the acceptance ratio by utilizing coordinated offers, hand-selected hiring managers and better focused recruiters, and an increased employee quality by using a centralized gatekeeper.

Referring now also to FIG. 2, therein is illustrated a more detailed diagram of the method of the Williams et al. patent application. First, hiring needs 1 are communicated 3 to the RRC 5. Candidates 20 are then identified from the collected resumes 15 and are provisionally associated with at least one of the hiring needs 1 communicated. These candidates 20 are telephonically screened and are invited 25 to attend an RRC interview day 4.

On the RRC interview day 4 to which the candidates were invited, they are preferably first briefed 27 regarding the RRC process and informed as to what they can expect. The candidates are then individually interviewed 30 while compensation reviews 35 and security checks 40 are conducted. Feedback 45 from the interview sessions 30 and 50 from the compensation reviews 35 and security checks 40 are used in a roundtable review 55 of each of the interviewed candidates, which leads to consolidated offer or thank-you letters being distributed 60. Finally, candidate follow ups 65 are conducted by the RRC of each candidate.

FIG. 3 illustrates the preferred steps of candidate identification as set forth by Williams et al. Prior to an RRC interview day, preparation activities are required. During the Interview Day Preparation phase, candidates are identified, Electronic Candidate Folders are created, an on-line review of candidate resume is performed, and candidate education occurs as described in the sections following.

Upon receiving job requirements from the Participating Business Units (divisions for example), Job Requisitions 65 are entered into a database 70 (hereinafter referred to as the Resumix Software System). At the same time, as potential applicant resumes 15 are received, they are scanned and input into the Resumix Software System 70.

Based on RRC Job Requisitions opened (unfilled for example), the Resumix system performs a search 75 against open requisitions 65 and resumes 15 to identify applicants that meet job requisition requirements. Upon matching an applicant to job requisition, an RRC Recruiter 80 telephones the identified applicant 85 and conducts a telephone screen 90 to determine if the skills and experience of the applicant match the received resume 15. Upon passing the telephone screen 90 the applicant 85 is invited to the RRC for an in-house interview. The candidate is scheduled for an interview appointment and is given a web site address, user name, and password to access the RRC external web site, and instructions on the web site applications required to be downloaded and filled out prior to arriving at the RRC.

The RRC Recruiter 80 sends 103 a soft copy of the applicant resume 15 via electronic mail from the Resumix Software System to a RRC Scheduler 95, as suggested in FIG. 4. In addition, a list of applicant names 100 that have been invited to interview are sent 104 via electronic mail to the RRC Scheduler 95, for use in preparing Interview Day Electronic Candidate Folders 110.

As also suggested in FIG. 4, upon receiving the list 100 of names of invited candidates and soft copy resumes 15 for each candidate, the RRC Scheduler 95 prepares 106 for the interview day. Accessing the RRC Alta Vista Forum 105, for example by using a commercial off the shelf software package available such as a web browser, the RRC Scheduler 95 creates an electronic folder 110 for the Interview Day for each candidate name. Each candidate folder 110 is populated with the associated candidate resume 15. Upon completing of the electronic candidate folder 110 preparation as described in conjunction with FIG. 4, an electronic mail message 120 is sent 121 to the Business Unit Hiring Managers 125, informing each manager 125 of the availability of candidate resumes 15 for review prior to arriving to the RRC for interviews.

Upon receiving an electronic mail notification 120 that resumes 15 are available on-line for review, Business Unit Hiring Managers 125 preferably review 123 candidate resumes 15 prior to the interview day. Resumes 15 are accessed using the RRC Alta Vista Forum 105 via a web browser. Preferably, hiring managers 125 select resumes 15 for review using two different methods. The first access method is through a selection of the Interview Day folder and subsequently through each Candidate Electronic Folder 110. The second method is through the use of a Search Engine to select candidate resumes using key word and date parameters.

Referring now also to FIG. 6, after receiving an invitation to interview at the RRC, each candidate 85 is required to call and schedule an appointment and to fill out employment forms 130 prior to the interview day. Each candidate 85 is provided a web site address and corresponding name and password to access the RRC external web site 135.

The RRC external web site 135 preferably serves as a vehicle to communicate the following information:

Information on the participating business units

Information about living and working in the business unit's geographical area

Information of preparing for a successful interview

Employment forms to download and fill out prior to arrival

Directions to the RRC

Visit preparation instruction

Upon accessing to the RRC Web Site 135, each candidate 85 downloads and preferably fills out the following employment forms 130:

Job Application

EEO Form

Conflict of Interest Form

Security Form

All forms 130 are preferably collected upon each candidate's 85 arrival to the RRC, but could also be electronically transferable to the RRC for example utilizing the website 135.

Referring now also to FIG. 7, at the same time of the general briefing 27, the RRC Scheduler 85 begins to populate the Regional Recruiting Information System (RRIS) 140, an access database which houses the results of the interview day, with Candidate Information 145 derived from the interviews, resume, phone interview, form set 130 (including security form 130′1, job application 130″, EEO form 130′″, and conflict of interest form 130″″). Candidate Information 145 that is captured in the RRIS 140 preferably includes:

Candidate Name

Candidate Title

Candidate E-mail Address

Candidate Work Phone Number

Candidate Home Phone Number

Candidate Fax Number

Candidate Address

Candidate City

Candidate State

Candidate Zip Code

Candidate Social Security Number

Candidate Ethnicity (Maintained in restricted files; entered if self identified)

Candidate Gender (Maintained in restricted files)

Candidate Comments

During a RRC Interview Day three main activities are performed by RRC Personnel. These activities include Candidate Check-In, Interview Sessions, and an end-of-interview-day Offer decision meeting as described in the following sections.

Upon arriving at the RRC, each candidate 85 is preferably welcomed by the RRC Receptionist 150. The RRC Receptionist 150 collects the employment application forms of form set 130 from each candidate 85 and then preferably escorts each candidate 85 to the technology lounge 155.

The technology lounge 155 provides a waiting area as candidates 85 wait for the Interview Sessions to begin. It provides a desktop area (preferably including kiosks 245) where each candidate 85 can access the external RRC web site 135 to continue to conduct research and where each candidate 85 can interact with business entity softcopy information materials. The I&S Section Information Program 160 provides insight into I&S Section Businesses, which participate in the RRC, and the products that are developed within the Information and Services Sector.

Upon receiving a hardcopy of each candidate folder 110′, the RRC Receptionist 150 provides the form package 130, with the exception of the Security Form 130′, to the compensation analyst 185 (FIG. 8), and the Security Form 130 to the Security Manager 165. At the beginning of each interview session, each candidate 85 is escorted into a large conference room and attends a general briefing. The general briefing 27 provides information on the hiring business entity, and educates the candidate 85 on the RRC and what to expect during the Interview Day.

Upon completion of the general briefing session 27, each candidate 85 is escorted back into the Technology Lounge 155 and awaits his first interview. The RRC Hiring Managers 125 and RRC Security Manager 165 introduce themselves to each candidate 85 in the technology lounge 155, as suggested in FIG. 8, and proceed to individually escort each candidate 85 to a designated Interview Room (not illustrated). Each candidate is interviewed and upon completion is escorted back into the technology lounge 155. Upon completion of each interview, a Hiring Manager 125 returns from escorting the Candidate 85 to the Interview Room and accesses the RRIS database 140. The Manager Information that is captured by the RRIS database 140 preferably includes:

Social Security Number

Business Identifier

Name

Title E-mail Address

Work Phone Number

Home Phone Number

Mail point

Fax Number

Comments

The Manager 125 enters a real-time assessment 170 of each candidate 85 derived at least in part from the interview. Hiring Interview information 170 which is captured preferably includes:

Hiring Manager Name

Business

Hiring Location, including City and State

Candidate Name

Position Interviewing for

Communication Skills Assessment

Technical Capabilities Assessment

Work Experience Assessment

Degree

Major

Years of Applicable Experience

Hiring Band, if required for business

Resume Accuracy Assessment

Compensation Range Assessment

Hire Status Assessment

Comments

Upon completion of a Security Interview, a Security Manager 165 returns from escorting a candidate 85 to the technology lounge 155 and completes a Security Interview Assessment 175 form which is kept separate from the RRIS 140. Security Interview information 175 captured preferably includes:

Candidate Name

Candidate Potential Clearance Level

Current Clearance Level

Current Clearance Status

Comments

Security Evaluation

Security Manager Name

Candidate 85 continues to interview based on a pre-set schedule for the Interview Day. At the end of the Hiring Manager 125 and Security Manager 165 interview set, each Candidate 85 meets with a recruiter 80. The Recruiter 80 escorts each candidate 85 to an interview room and conducts a closing interview. Upon completion of the Closing Interview, each candidate 85 is preferably thanked for his time and completes the interview day. The Recruiter 80, upon escorting the Candidate 85 back to the Receptionist 150 returns to the interview room and access the RRIS 140 to enter a closing interview assessment 180. Closing Interview Assessment information 180 captured preferably includes:

Recruiter Name

Candidate Name

Current Salary (if applicable)

Last Increase (percentage, if applicable)

Last Increase Amount (dollars, if applicable)

Time of Next Review (if applicable)

Minimum Salary Requirements

Location Preference/Business Name

What it will take for the candidate to work for Business entity

Additional Comments

During the Interview Session, an RRC Compensation Analyst 185 accesses the RRIS database 140 and reviews interview assessment data 170 for each candidate 85. Based on the assessment data 170, the Compensation Analyst 185 determines a price point to offer to each candidate 85 and enters the Compensation Analyst assessment 190 into the RRIS database 140. The Compensation Analyst Assessment 190 preferably includes:

Compensation Analyst Name

Compensation Offer

Comments

Referring now also to FIG. 9, upon completion of all Interviews for the interview day, all personnel (80, 125, 165, 185) who have been active in the interview day meet at the end of the interview day to discuss candidate offers for select candidates 85. Preferably, a director 195 of the RRC acts as the facilitator of the offer decision meeting.

During the offer decision meeting, the RRC Director 195 facilitates a review of each candidate 85 that attended the interview day. Each candidate=s Interview Assessment Data (170, 175, 180 and 190) are reviewed and an offer, including price, and companies offering a position are determined. The RRIS database 140 is preferably projected from a desktop platform onto a large conference screen for the Director=s 195 use in facilitating the session for example. Final offer decision information 200 is captured in the RRIS database 140 upon agreement for each candidate 85. Offer Decision information 200 captured preferably includes:

Business

Hire Decision

Hiring Manager

Compensation Offer

Sign-On Bonuses

Decision Comments

Any candidate 85 not receiving an offer is reflected as rejected in the database 140. Candidates 85 are preferably defined with the following Hiring Statuses:

No Hire

Hire for Business entity

Potential Hire for Future

Hire for other hiring need of Business Entity.

Upon completion of the Offer Decision Meeting, a Candidate Offer Decision Report 210 is preferably cycled and printed from the database 140.

Referring now also to FIG. 10, after the Interview Day Decision Offer Meeting, a series of Post-Interview activities are performed. These activities include Offer Letter Preparation and Applicant Tracking Updates as described in the following sections.

Upon completion of an Interview Day, the RRC Scheduler 95 accesses the RRIS database 140 and runs the automated Offer Letter and Thank You Letter Reports 220. Each candidate 85 who has not received an Offer Letter 220 is sent a thank You Letter 220. The Offer Letters 220 and Thank You Letters 220 are exported from the RRIS database 140 into a Rich Text Format file for example. Using Microsoft Word or any other suitable means, the Scheduler 95 reviews and concatenates the Offer Letters 220 down to one Offer Letter 230 per candidate using the Offer Letter Decision Report to ensure that all Offers are reflected in each letter 230. In addition, the Thank You Letters 220 are reviewed in soft copy format prior to printing hard copy versions 230.

Upon completion of the Offer Letter and Thank You Letter soft copy preparation 220, the letters are printed (230) and provided to the assigned RRC Recruiter 80 for final review, and approval. Upon receiving the approval, including the Recruiter 80 signature, each letter 230 is sent 231 to the respective candidate 85, preferably by Federal Express for example.

Referring now also to FIG. 11, along with reviewing and approving the Offer or Thank You Letter 230, each Recruiter 80 preferably logs into the Resumix Software System 70 and updates the Applicant ADisposition≅ and AOffer≅ Statuses 240 for each candidate 85 that has interviewed for an LMC position. If a Candidate 85 has not been extended an offer, the Disposition statuses 240 preferably reflect the reasons for the decision.

If an offer is extended, upon receipt of a candidate's 85 response, the candidate's decision data is entered into an AAccept≅ or AReject≅ status fields within the Applicant status 240, in addition to the candidate's AHire Date≅ if applicable.

Referring now also to FIG. 12, preferably the technical center includes multiple kiosks, each of which preferably include a Pentium II computer, a mouse, a keyboard, a flat panel display, an Internet browser such as Netscape Communicator, other Internet software such as NetNanny, and productivity software such as Microsoft Office or the like (collectively designated as 245).

Preferably, each interview room includes a Pentium computer for example, a mouse, keyboard, monitor, Internet browser such as Netscape Communicator, virus protection software, and other software such as Adobe Acrobat and Microsoft Office for example (collectively designated 450). Additionally, each interview room computer preferably includes a QWS3270 TN 3270 emulator for communicating with existing hardware (mainframe) and for accessing the database 140 for example. Preferably, the server/router/switch/hub configuration includes a Cisco 4500 Router 455, Cisco 5000 Switch 460, Cisco 1924 Hubs 465, and a Compaq 2500 Fileserver with NT Server w/service pack 470 for example. Also, a connection 250 to the entity's existing network 255 is provided. Preferably the Kiosk Internet Proxy Server 475 includes a Compaq 2500 Fileserver with NT Server w/service pack, and Netscape Proxy Server and server to insulate the kiosks 245. Preferably each manager 125 is equipped with a Pentium II laptop, mouse, keyboard, docking station, display, modem, Ethernet adapter, an Internet browser such as Netscape Communicator, virus protection software such as McAfee Antivirus and other software such as Adobe Acrobat Reader and Microsoft Office Professional (collectively designated 475). Preferably each managers 125 laptop further includes a QWS3270 TN3270 emulator.

Referring now to FIG. 13, estimated scaled-up results from a pilot program consistent with the Williams et al. arrangement are therein illustrated. As illustrated therein, resumes 15 were collected 240 using sources such as media 260, job fairs 265, head hunters 270, employee referrals 275 and other sources 280, and fed into the Resumix server 290. These resumes 15 were then down selected 285 and phone interviews led to candidate scheduling 290. Interviews were conducted 295, offers were extended 300 and employees started working 305. Estimating 35,676 resumes to be received each year, approximately 10% or 3,568 would be down selected and scheduled for an interview assuming 109 interview days per year. Of these 3,568 candidates 10% are estimated as not to show resulting in 3,243 interviews being constructed each year. Of these 3,243 being interviewed approximately 74% or 2,400 are estimated to be offered jobs, 50% of those offered jobs or 1,200 are estimated to accept the offer.

### SUMMARY OF THE INVENTION

A networked method and system according to an aspect of the invention is for recruiting personnel for a business entity having a plurality of distinct business units, where each of the distinct business units has individual hiring requirements, and which may compete for the same job applicants. The method comprises the step of correlating hiring needs from at least one of the distinct business units with information from resumes of job hunters to identify putative job candidates from whom a job or employment application is desired. A single electronic docket is set up for each of the putative job candidates. The single electronic docket is made available on a network. The network may include intranet and Internet portions, and the intranet portion may include plural databases. According to an aspect of the invention, each putative job candidate is provided, by way of the network, with access to electronic job application forms, which when filled out and returned over the network by each the putative candidate become part of the single electronic docket of a job candidate. Information is entered into the single electronic docket of the putative job candidate to the effect that the forms were so provided. Each job candidate is provided, by way of the network, with an invitation to an interview, specifying the time and location for the interview. A notation is made in the single electronic docket identifying at least the time and location of the interview. Substantially simultaneously with the provision of the invitation, and by way of the network, a selected hiring manager is advised of the scheduling of the interview, and providing access by way of the network to the single electronic docket associated with the job candidate who is to be interviewed. An interview is conducted between the selected hiring manager and the job candidate, and a hiring assessment is entered by the selected hiring manager into the single electronic docket. In one version of the method of the invention, substantially simultaneously with the interview, and by way of the network, an assessment is performed of at least one of security and compensation based upon the information in the single electronic docket, and the result of the assessment is entered into the single electronic docket. Substantially simultaneously with the interview, the contents of the single electronic docket are reviewed by recruiting personnel, and a decision is made as to whether to make an offer to the job candidate. The results of this decision are entered into the single electronic docket. If the decision is affirmative, a hard-copy paper offer may be electronically generated for transmission to the job applicant.

In a preferred mode according to an aspect of the invention, the step of making a decision as to whether to make an offer to the job candidate is made on the same day as that on which the interview takes place.

In a particular mode of a method according to an aspect of the invention, the step of electronically generating a hard-copy paper offer is performed substantially simultaneously with the step of transmitting information relating to the offer by way of the network to the job applicant.

In another mode of a method according to an aspect of the invention, the step of providing each putative job candidate, by way of a network, with access to electronic job application forms, further comprises the step of providing the putative job candidate with a code which allows access to the forms, and which allows the forms, when filled out, to enter the single electronic folder.

### BRIEF DESCRIPTION OF THE DRAWING

FIG. 1 is a simplified diagrammatic representation of overall employee hiring as described in conjunction with the Williams et al. patent application;

FIG. 2 is a simplified diagrammatic representation including more detail than that of FIG. 1;

FIG. 3 is a simplified diagrammatic representation of candidate identification steps which may be used in the diagrams of FIGS. 1 and 2;

FIG. 4 is a simplified diagrammatic representation of electronic candidate folder preparation steps which may be used in conjunction with FIGS. 1 through 3;

FIG. 5 is a simplified diagrammatic representation of resume reviewing steps which may be used in conjunction with FIGS. 1 through 4;

FIG. 6 is a simplified diagrammatic representation of interview day preparation steps which may be used in conjunction with FIGS. 1 through 5;

FIG. 7 is a simplified diagrammatic representation of interview day steps which may be used in conjunction with FIGS. 1 through 6;

FIG. 8 is a simplified diagrammatic representation of interview session steps which may be used in conjunction with FIGS. 1 through 7;

FIG. 9 is a simplified diagrammatic representation of offer decision steps which may be used in conjunction with FIGS. 1 through 8;

FIG. 10 is a simplified diagrammatic representation of offer letter preparation steps which may be used in conjunction with FIGS. 1 through 9;

FIG. 11 is a simplified diagrammatic representation of applicant tracking steps which may be used in conjunction with FIGS. 1 through 10;

FIG. 12 is a diagram illustrating a preferred embodiment of network interconnection utilized by the method of FIGS. 1 through 11;

FIG. 13 illustrates estimated scaled up results obtainable using the method and system of the Williams et al. patent application;

FIG. 14 is a simplified diagrammatic overview representation of the overall concept of an aspect of the invention;

FIG. 15 is a simplified diagrammatic representation of putative candidate identification and invitation steps which may be taken in the method of FIG. 14;

FIG. 16 is a simplified diagrammatic representation of assignment of an interviewing manager steps which may be taken in the method of FIG. 14;

FIG. 17 is a simplified diagrammatic representation of steps which may be taken by a hiring manager in conjunction with the method of FIG. 14;

FIG. 18 is a simplified diagrammatic representation of steps which may be performed by the hiring network in conjunction with the method of FIG. 14;

FIG. 19 is a simplified diagrammatic representation of steps which may be performed in conjunction with interview day in relation to the method of FIG. 14;

FIG. 20 is a simplified diagrammatic representation of steps which may be performed in conjunction with interview day in relation to the actual interviews, to memorialize information derived from the interviews, in relation to the method of FIG. 14;

FIG. 21 is a simplified diagrammatic representation of steps which may be performed in conjunction with interview day in relation to making a hire-no hire decision, to memorialize the decision, and also illustrating some steps taken by the hiring network, in relation to the method of FIG. 14;

FIG. 22 is a simplified diagrammatic representation of steps which may be performed to actualize or implement the decisions arrived at in conjunction with FIG. 21, and also illustrating some steps taken by the hiring network, in relation to the method of FIG. 14; and

FIG. 23 is a simplified diagrammatic representation of steps which may be performed by the hiring network of FIG. 14 to update docket information in response to information entered either electronically or manually.

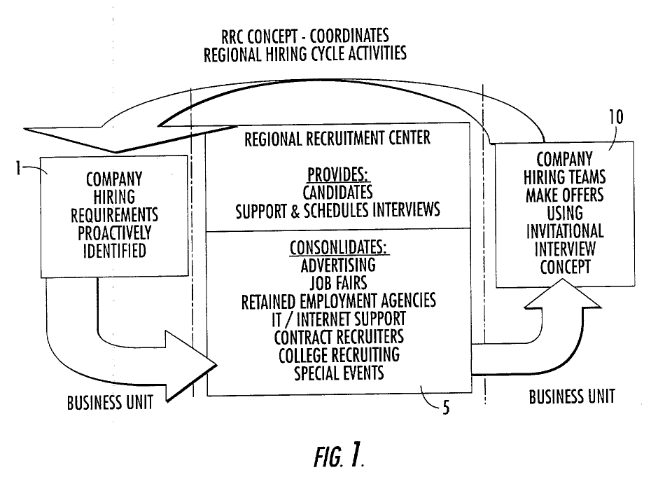

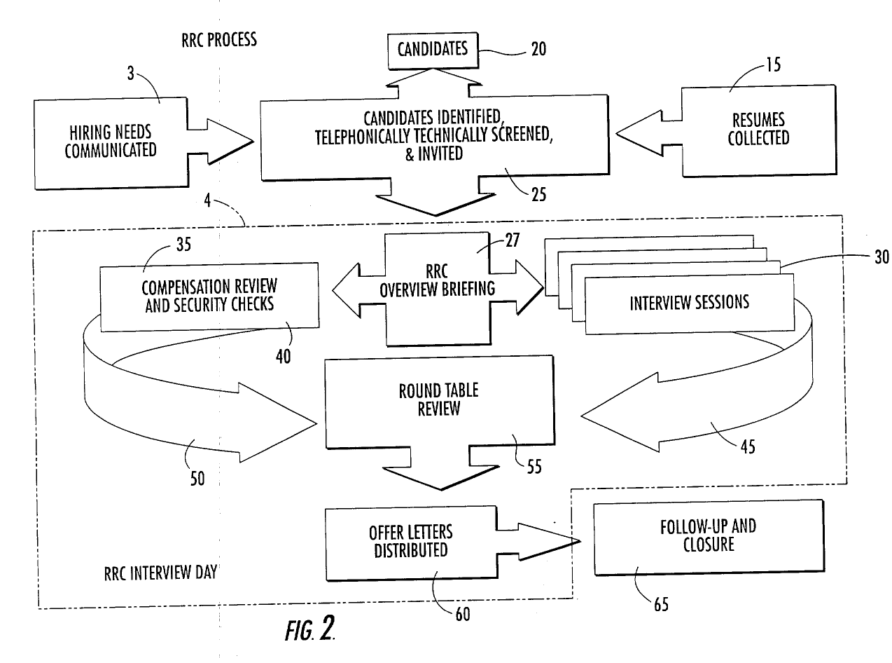

### DESCRIPTION OF THE INVENTION

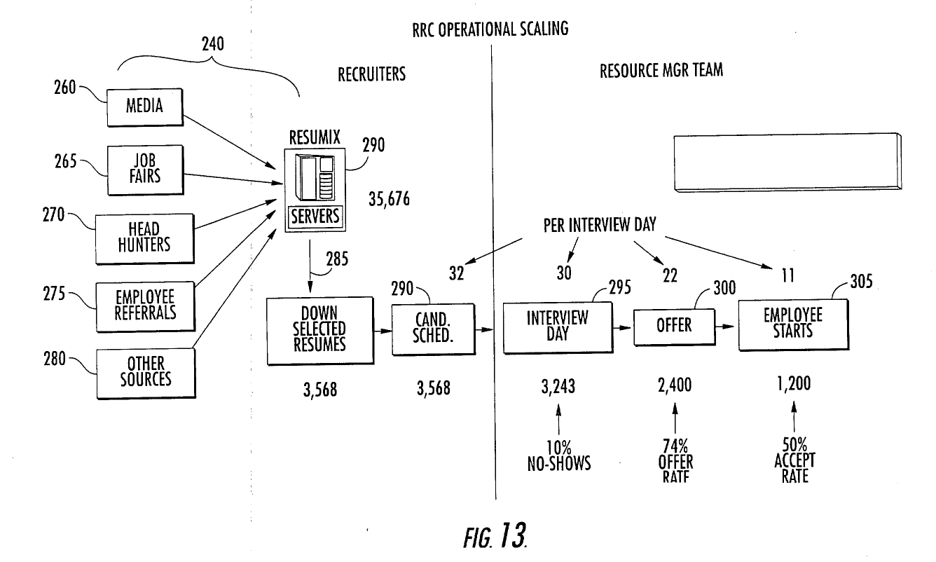

In FIG. 14, a network arrangement includes a firewall 1410 separating Internet 1412 and intranet 1414 portions of an interconnected hiring network or hiring system 1400. The hiring network 1400 interconnects the candidate on the Internet with the RRC external web site and with various databases, such as the Sunnyvale Resumix System 70, and the RRC access database 140 on the Intranet. According to a general aspect of the invention, candidate recruiting is performed using a single electronic candidate docket, electronic folder (E-folder) or file 1408 for each job applicant or candidate 1485, which is communicated by way of the single hiring network or system to the various recruiting andor hiring personnel as may be required for them to perform their functions. It should be understood that the job seeker or job candidate 1485 of FIG. 14 can be considered to be a “putative” job candidate before the time at which he fills out and returns his job application forms, and may be considered to be a job candidate or job applicant thereafter.

In FIG. 14, a recruiter 80 seeks out putative job applicants, or receives solicited or unsolicited resumes from such putative job applicants, and enters information relating to those putative job applicants into the hiring network 1400. Initially, the available information may not much exceed the name and Internet address of the person identified by a resume. Generally speaking, the recruiter, with the aid of the hiring network, compares the hiring requirements on the hiring network 1400 with resume information of the putative job candidate, and identifies those putative job candidates who merit further attention. Those job candidates are contacted, preferably over the hiring network, and provided with electronic password codes and application forms. The electronic forms, when filled out and returned by the putative job candidate, are automatically routed to the single electronic docket 1408 for that candidate, and form the basis for further action. The candidate's filled-out electronic forms may be reviewed to verify that the candidate conforms to the original resume which was the basis for the contact with the job seeker, and the recruiter 80 may then assign or negotiate an interview date with the candidate. When a date has been set, the candidate electronic docket may contain a candidate identification, which may be his name, or an alphanumeric code, or some combination thereof. The docket will also contain the scheduled interview date, filled-out application form, Fair Credit Reporting Act form, Conflict-of-Interest form, Export Control form, and possibly some detailed other information about the candidate. The information is available on the hiring network 1400, and particularly on the intranet 1414 portion thereof, to various authorized persons in the hiring groups. As illustrated in FIG. 14, one or more hiring managers 125, a security manager 165, and a compensation analyst 185 access the hiring network 1400 to obtain almost-real-time information about the job seekers and candidates whose information is found on the network. Since, after the initial contact with the putative candidate by the recruiter, information is electronically entered into the hiring network 1400, the information thereon should be as up-to-date as can reasonably be expected.

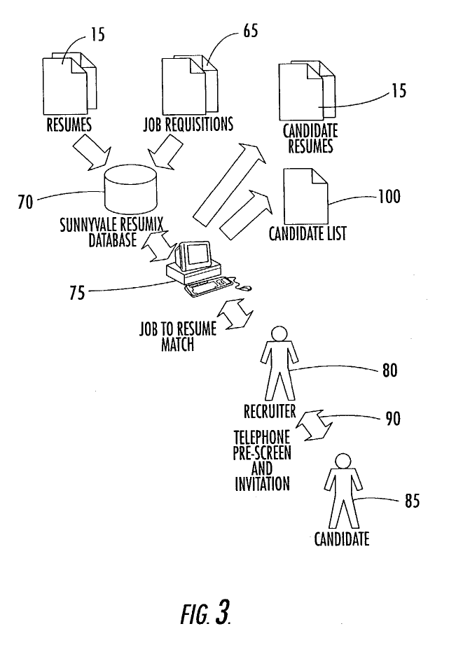

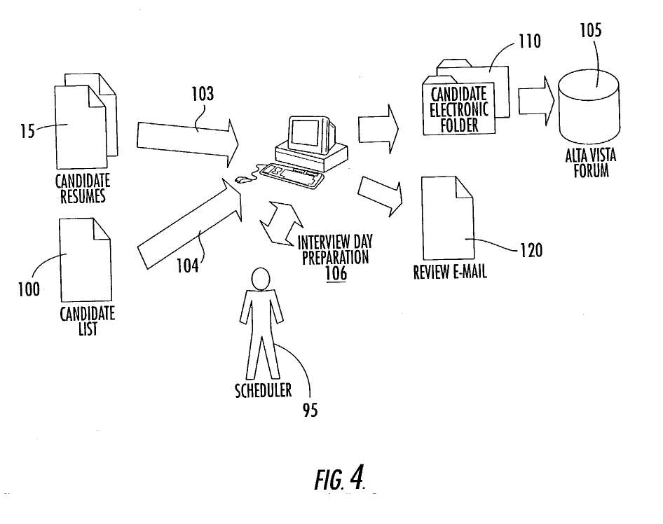

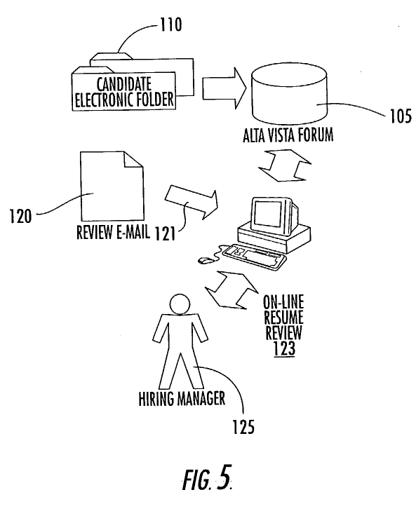

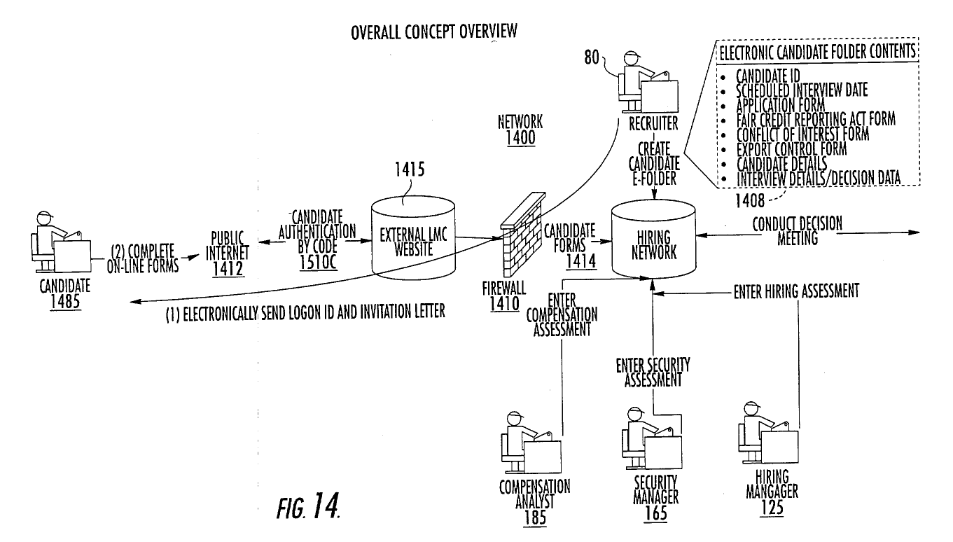

FIG. 15 is a simplified representation of the applicant sourcing or locating according to an aspect of the invention, which may be compared with FIG. 4. Elements 15, 65, 70, 75, and 100 are as described in FIG. 3. It should be noted that resumes 15 may be the first contact with a putative job candidate, and these resumes are scanned or otherwise processed and entered into the Sunnyvale Resumix Database portion 70 of the hiring network 1400.

While ideally, if one were starting without a base of installed equipment, a single database would be used in the hiring network 1400 to contain the single docket, folder or file for each candidate, the existence of previously installed databases makes it more convenient to integrate an existing database, such as Resumix, into the hiring network database by providing a pointer associated with each single docket, folder or file which points to the corresponding resume in Resumix. Thus, a person accessing a single docket, folder or file on the hiring network perceives the system as being unitary, requiring no special steps to access databases which are not co-located with the hiring network database.

Once one or more resumes are entered into the Resumix database 70 of FIG. 15, they are available as item 15 by accessing the hiring network 1400. The recruiter 80, with the aid of the hiring network 1400 database portion 70, correlates the hiring needs with the available resume information from job hunters, to produce information relating to putative job candidates, who should be asked to apply for a job. An invitational email 1514 and link to the candidate folder is sent to the hiring manager from hiring network 1400. Item 90 of FIG. 15 represents a telephonic pre-screen of the candidate by a recruiter 80 and (should the pre-screen be successful) issuance of an invitation. Recruiter 80 also imports the resume information (that is, the candidate name and requisition data) into the hiring network 1400 from Sunnyvale Resumix, and enters the candidate invitation data, as suggested by arrow 1508.

Since the putative candidate, for security reasons, cannot be allowed direct access to the intranet portion of the hiring system, an external website portion of the hiring network, illustrated as 1415 in FIG. 14, is provided, with which the putative job candidate can interact in a fashion limited by the properties of the web site.

In FIG. 15, while the recruiter 80 is allocating the putative candidate 1485 to an interview day and time, the hiring system, including hiring network 1400, generates an invitation email letter 1510 and an invitation code or password 1510c which is provided in the body of the letter. The code 1510c is one which is selected to authorize or allow the user to enter the external website 1415 of FIG. 14, and is unique to each candidate and has a short life before expiry, so that candidates will find it difficult to share the code. The letter 1510 is then emailed 1512 to the putative candidate 1485 over the network. Thus, while the recruiter 80 is allocating the candidate to an interview day and time, the hiring system automatically generates an invitation letter and an invitation code which is provided in the letter body. The letter is then emailed to the candidate, who may use the code as authorization to the company website, where forms are completed on-line. This tends to eliminate paper, provides real-time scheduling and efficiency, and the ability to distribute components of the process across the company regardless of their actual location.

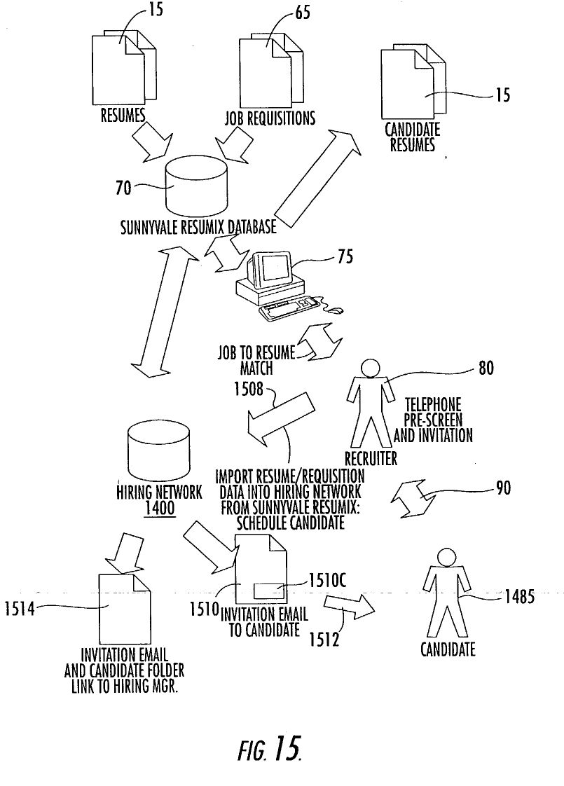

FIG. 16 is a simplified diagrammatic representation of a portion of the method of FIG. 14, somewhat similar to the method of FIG. 4, but differing therefrom. In FIG. 16, the candidate resumes 15 in electronic form are made available 1603, by pointers as described above, to the single networked candidate electronic docket or folder 1408. The preparation for interview day 106 is performed by the Recruiter 80 rather than by the scheduler 95. The same recruiter 80 that scheduled the putative candidate and emailed the invitation letter to the putative candidate, as described in conjunction with FIG. 15, also selects the interviewing manager, as suggested by the Interview Day Preparation 106, and that selected interviewing manager automatically receives a copy 120 of the “invitation email & candidate folder” link, which advises the hiring manager that the particular candidate is scheduled with him for a particular day and time. That email to the manager(s) also provides a link by which the managers can log into the hiring network for review of the single electronic docket of that putative candidate or for an overview of the current schedule for the specific calendar date, as described in more detail in conjunction with FIG. 17. By comparison with the corresponding sourcing portion of the method of Williams et al., described in conjunction with FIGS. 3 and 4 above, the role of the scheduler 95 is eliminated in FIGS. 15 and 16, with concomitant elimination of paper, and the offer information is immediately available on the hiring network 1400 to the selected managers and to any authorized person in the hiring company.

Another salient advantage of the aspect of the invention described in conjunction with FIGS. 15 and 16 is that the candidate 1485 receives electronic application forms to fill out, which when filled out and returned (in conjunction with the code or password 1510c are automatically incorporated into the candidate's electronic docket, without further intervention. There is no need in the arrangement of FIG. 15 according to this aspect of the invention to take any action to advise the Alta Vista Forum 105 of the data contained in a received in a candidate resume, because the Alta Vista Forum, or at least its functions, are incorporated into hiring network 1400.

In FIG. 17, the candidate electronic folder 1408 in the hiring network 1400 is immediately accessible 1481 by the hiring manager 125 who receives the email 120 from the hiring network. FIG. 17 illustrates accessing of the resumes of the various candidates by means of the hiring network 1400, which are available as early as initial contact with the putative candidate, and even before an initial contact of the recruiter 80 with the putative candidate.

In FIG. 17, the electronic candidate folder, possibly containing as little as a scanned resume, is available for review 123 by the hiring manager 125 or other authorized person. This method has the advantage that no additional step is required before the resume becomes available to the hiring manager. Such resume/dockets may be reviewed by the hiring manager based on the date of receipt of the resume, since, as to a putative candidate whose only contact has been through the sending of a resume, little other relevant information is available. At a later time, of course, when the candidate is scheduled, the single dockets for each candidate may be reviewed by candidate name or interview schedule date.

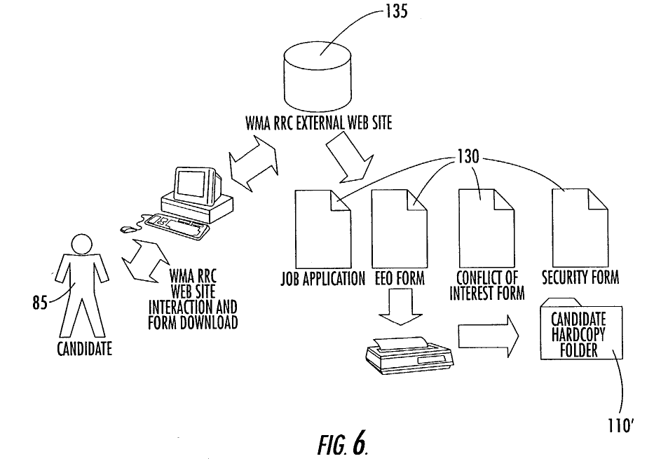

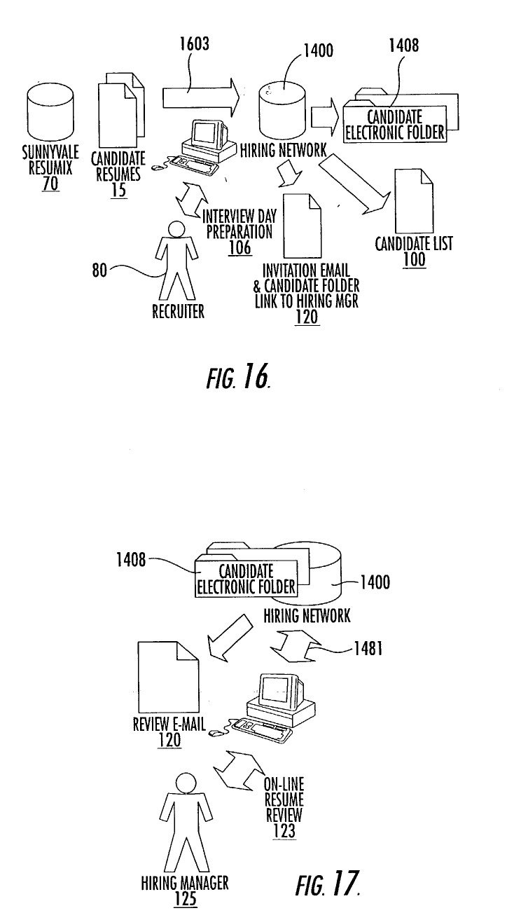

In FIG. 18, candidates 1485 interact with External LMC Website 145 by filling out the online forms, adding the code or password, and returning the filled-out forms to the external website. Ideally, the forms 130 which are handled on-line include a corporate-wide job application form, Fair Credit Reporting Act form, Conflict-of-Interest form, and Export controls form. All of these filled-out forms are stored by the hiring network 1400 in the electronic folder 1610 for the particular job candidate. Other site-specific forms, such as EEO forms and security forms, illustrated together as 1820, can be provided in electronic or printed form. FIG. 18 differs from FIG. 6 in that the various pieces of data designated as 130, previously handled as separate items, are combined 1810 into the electronic candidate docket or folder 1408 on hiring network 1400. Since all functions are performed on an interconnected hiring network, the various functions need not be co-located in order to achieve time savings and short turn-around in hiring.

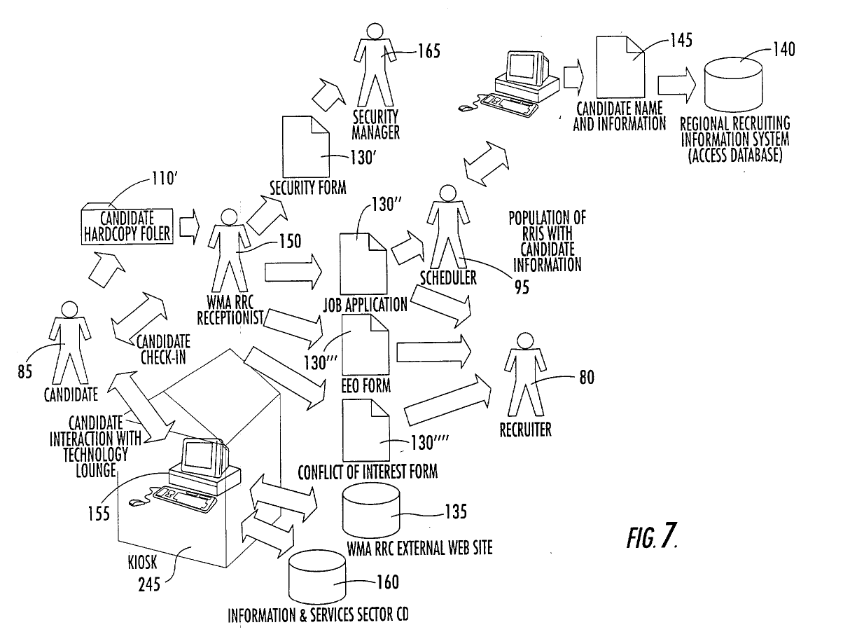

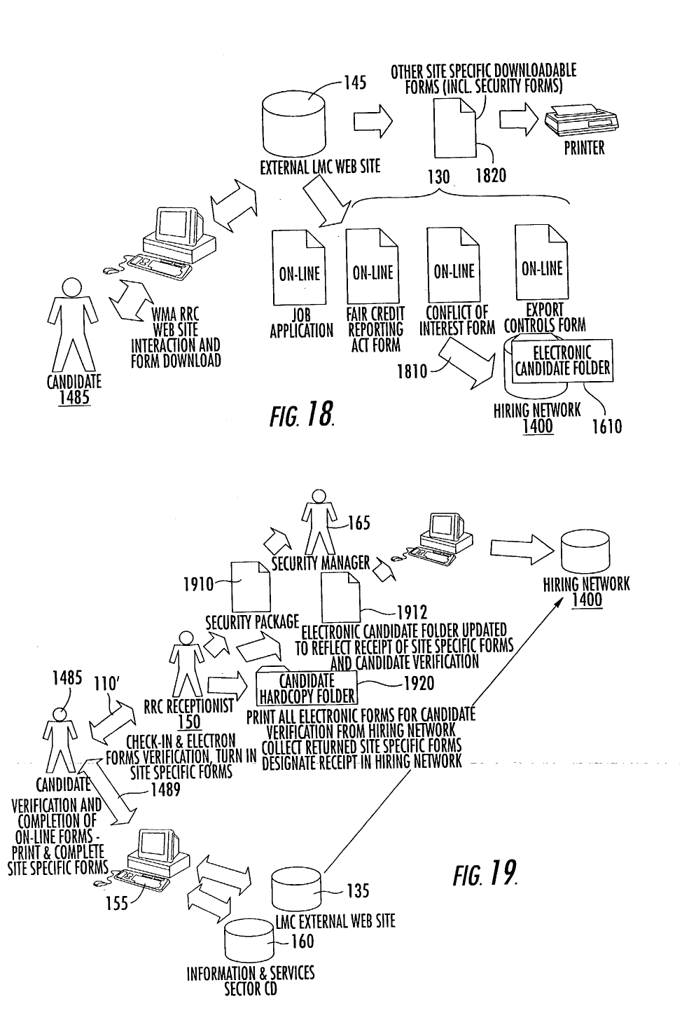

On the appointed interview date, the steps of FIG. 19 may be taken in accordance with an aspect of the invention. In FIG. 19, the candidate 1485 provides filled-out hard copy site-specific forms 110′ (if not already filed electronically) to receptionist 150, who retains the form package until the arrival of the first key operative, who may be the recruiter 80, the security manager 165, or one or all of the hiring managers 125, all described in conjunction with FIGS. 7 and 8. The candidate verifies and completes on-line forms as necessary, and signs a verification. The verification is printed and filed 1920 by the receptionist as hard copy in a backup or archival candidate folder. The receptionist 150 also updates 1912 the candidate's electronic folder with any modifications received from the candidate, with the aid of an electronic checklist of all the corporate and site-specific forms. The security package is routed 1910 to the security manager 165. The hiring network displays information, together with a checklist component of the electronic candidate folder, to all interested and authorized parties, including hiring managers and recruiting center staff. This information indicates by the checklist the state of completion of the various forms, and identifies any incomplete forms and the missing or invalid information. The candidate 1485 is asked by the receptionist 150 to use the technology lounge 155 to complete any incomplete forms, which information is immediately coupled to the LMC External Web site 135 and to a link, designated Information & Services CD, to each business entity and to their respective external websites, for further candidate exploration. In this manner, there is no need to route hard-copy folders, except for the security package. Because of the nature of the information contained in the security package, only security specialists are permitted access; the receptionist is not permitted to view the security material, but instead routes a separate sealed folder directly to security. Any other hardcopy matter is placed in the archival file, so there is no chance of their being misplaced or lost. The forms are complete at the time of the interviews, and not only key information, but all information relating to a given candidate, is simultaneously available to all authorized potential users.

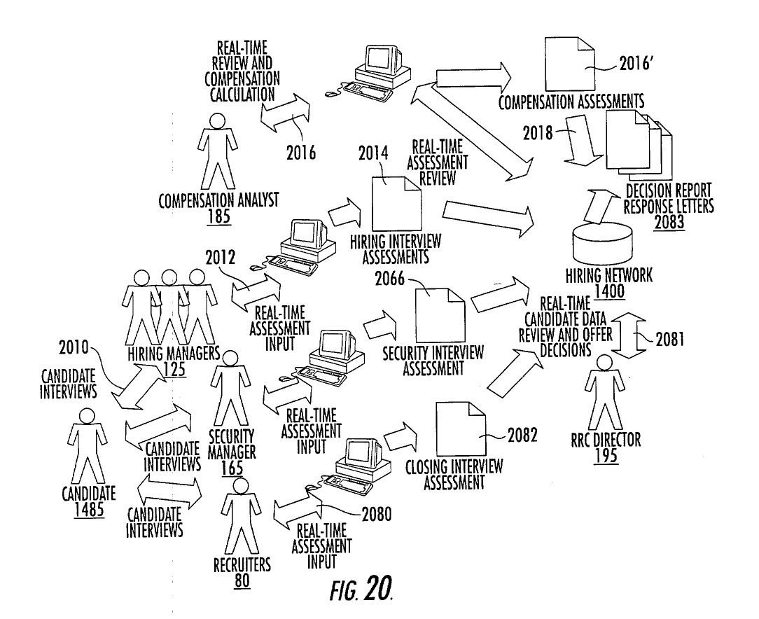

FIG. 20 is a simplified representation of interview and related activities which take place during the interview day, according to an aspect of the invention. In FIG. 20, the security manager 165 and the recruiter 80 interview the candidate 1485, and enter 2065, 2080, respectively, their assessments 2066, 2082, respectively, directly into the single electronic docket of the corresponding candidate on the hiring network 1400. Similarly, the hiring manager(s) 125 interview 2010 the candidate 1485, and after the interview enter 2012 their assessments 2014 into the candidate's docket in hiring network 1400. The compensation analyst 185 does not interview the candidates, but instead reviews 2016 the online information on the hiring network 1400 to arrive at a compensation assessment 2016′ which is entered 2018 directly into the candidate docket on the hiring network 1400. The RRC director 195 interacts 2081 with the hiring network 1400 to produce decision reports and response letters 2083

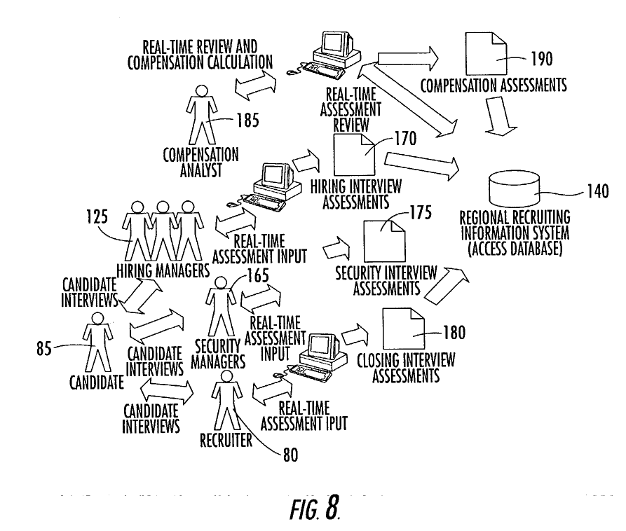

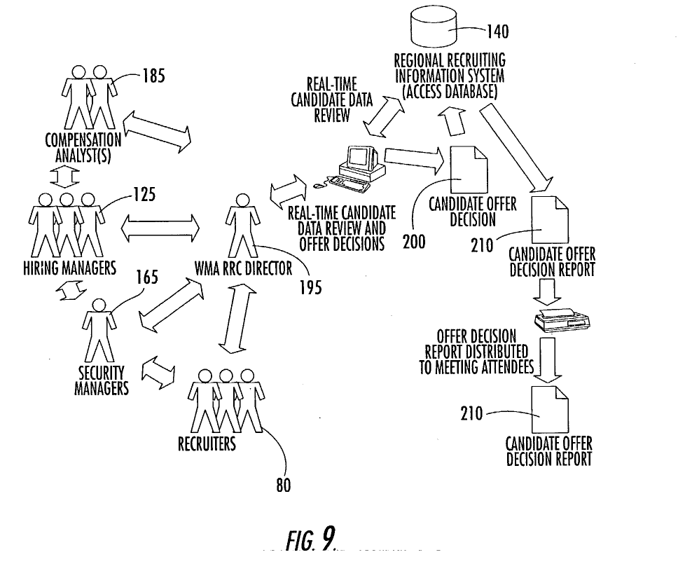

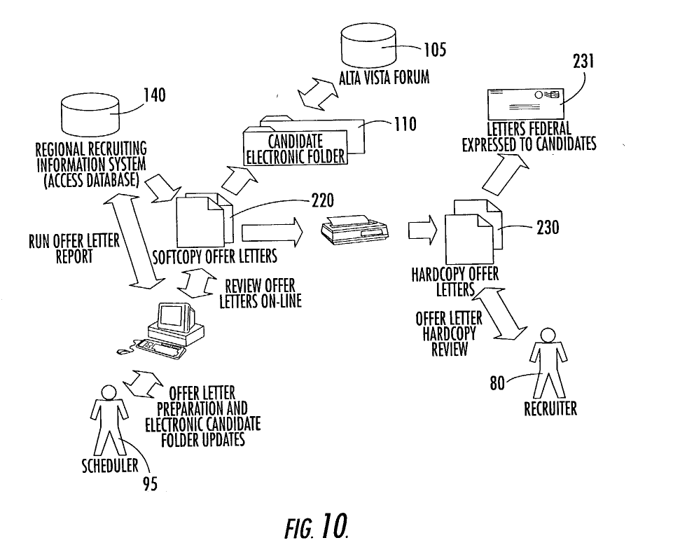

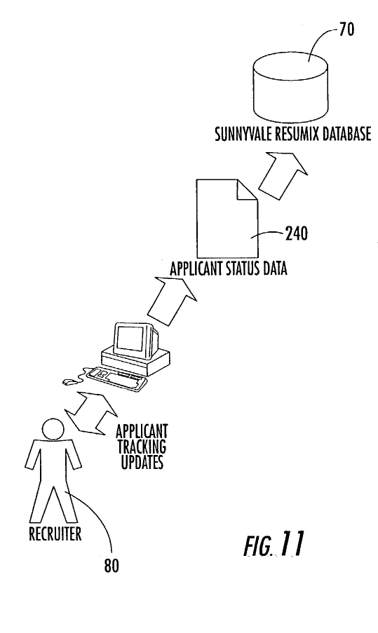

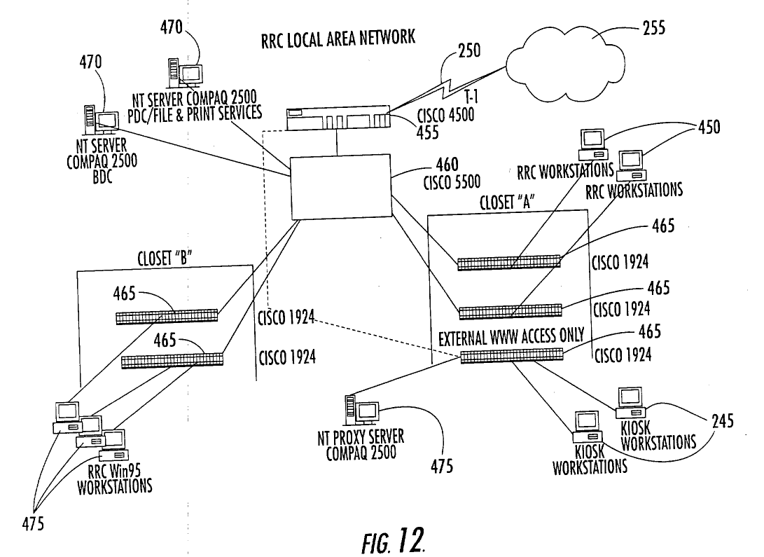

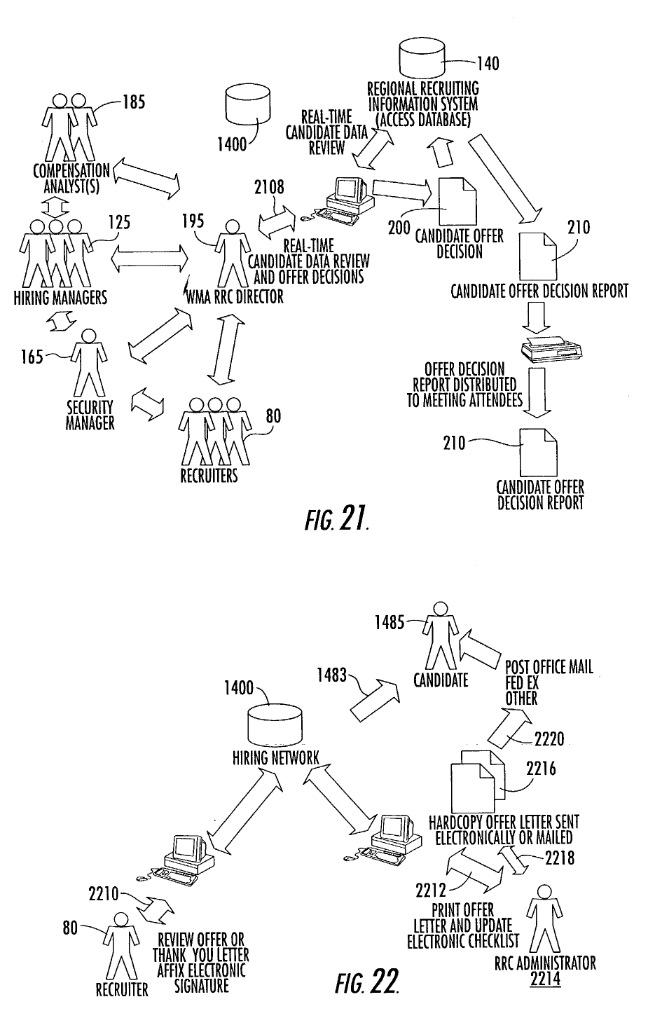

FIG. 21 is a diagrammatic representation of activities which take place after the interviews on interview day. As illustrated, most of the steps are similar to those described in conjunction with FIG. 9, up to the making of a hire/no-hire decision, designated 2108 in FIG. 21. The salient difference is that those participants in the decisionmaking process who do not actually need to meet the candidate, such as the compensation analyst 185, can participate in the decisionmaking from a remote site by way of communications including the network 1400. When the hire/no hire information is entered into the hiring network 1400, it is immediately communicated to the Sunnyvale Resumix portion of the network, and the “thanks” letter 2120 and offer letter 210 can be automatically generated.

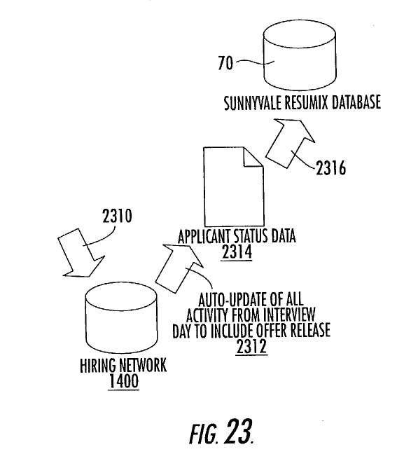

FIG. 22 is a simplified diagrammatic representation of those steps according to an aspect of the invention which follow the hiring decision. The recruiter 80 verifies the offer or thank-you letter and affixes 2210 an electronic signature, and the information so entered is applied directly to the hiring network 1400. A message is then sent, as suggested by arrow 1483, by way of the internet to the job candidate 1485, if the system is so programmed. The information is simultaneously accessible 2212 to an RRC administrator 2214 who causes hard copy 2216 to be automatically printed 2218 and prepared 2220 for transmittal, by post office mail, Federal Express, or otherwise, to the candidate 1485.

Follow-up after the interview day is performed by steps illustrated in the simplified diagrammatic representation of FIG. 23. In FIG. 23, the hiring network receives inputs 2310 from the various decision-makers, and, save for those inputs, operates autonomously to maintain 2312 the applicant's status 2314, and to update 2316 the Sunnyvale Resumix database 70.

Other embodiments of the invention will be apparent to those skilled in the art. For example, there may be cases in which the job candidate information is of a type which should not appear on even a relatively secure networked system, but rather should be handled separately, as for example security information; such information would not be expected to be found in the single file or folder on the network, except in summary form.

A networked method and system according to an aspect of the invention is for recruiting personnel for a business entity having a plurality of distinct business units, where each of the distinct business units has individual hiring requirements, and which may compete for the same job applicants. The method comprises the step of correlating hiring needs from at least one of the distinct business units with information from resumes of job hunters to identify putative job candidate(s) (1485) from whom a job or employment application is desired. A single electronic docket (1408) is set up for each of the putative job candidates (1485). The single electronic docket (1408) is made available on a network (1400). The network (1400) may include intranet (1414) and Internet (1412) portions, and the intranet (1414) portion may include plural databases (70, 105, 140). According to an aspect of the invention, each putative job candidate (1485) is provided, by way of the network (1400), with access to electronic job application forms, which when filled out and returned over the network (1400) by each the putative candidate (1485) become part of the single electronic docket (1408) of a job candidate (1485). Information is entered into the single electronic docket (1408) of the putative job candidate (1485) to the effect that the forms were so provided. Each job candidate (1485) is provided, by way of the network (1400), with an invitation (1510) to an interview, specifying the time and location for the interview. A notation is made in the single electronic docket (1408) identifying at least the time and location of the interview. Substantially simultaneously with the provision (1512) of the invitation, and by way of the network (1400), a selected hiring manager (125) is advised of the scheduling of the interview, and providing access (123) by way of the network (1400) to the single electronic docket (1408) associated with the job candidate (1485) who is to be interviewed. An interview is conducted between the selected hiring manager (125) and the job candidate (1485), and a hiring assessment (2012) is entered by the selected hiring manager (125) into the single electronic docket (1408). Substantially simultaneously with the interview, and by way of the network (1400), an assessment (2065; 2016) is performed of at least one of security and compensation based upon the information in the single electronic docket (1408), and the result of the assessment is entered into the single electronic docket (1408). Substantially simultaneously with the interview, the contents of the single electronic docket (1408) are reviewed by recruiting personnel (80, 125, 185, 195), and a decision (2108) is made as to whether to make an offer to the job candidate (1485). The results of this decision are entered into the single electronic docket (1408) on the hiring network (1400). If the decision is affirmative, a hard-copy paper offer (210) may be electronically generated for transmission to the job applicant.

In a preferred mode according to an aspect of the invention, the step of making a decision (2108) as to whether to make an offer (210) to the job candidate (1485) is made on the same day as that on which the interview takes place.

In a particular mode of a method according to an aspect of the invention, the step of electronically generating a hard-copy paper offer (210HC) is performed substantially simultaneously with the step (1405) of transmitting information relating to the offer by way of the network (1400) to the job applicant (1485).

In another mode of a method according to an aspect of the invention, the step of providing each putative job candidate (1485), by way of a network (1400), with access to electronic job application forms, further comprises the step of providing the putative job candidate (1485) with a code (1510c) which allows access to the forms, and which allows the forms, when filled out, to enter the single electronic folder (1408).

What is claimed is

1. A networked method for recruiting personnel for a business entity having a plurality of distinct business units, each having individual hiring requirements, in which at least some of said distinct business units compete for the same applicants, said method comprising the steps of:
correlating hiring needs from at least one of said distinct business units with information from resumes of job hunters to identify putative job candidates from whom a job application is desired;
setting up a single electronic docket for each said putative job candidate, and making said single electronic docket available on a network;
providing each said putative job candidate, by way of said network, with access to at least electronic job application forms which are common to all business units of said business entity, which when filled out and returned over said network by each said putative candidate becomes part of said single electronic docket of a job applicant, and entering into said single electronic docket of said job applicant information relating to at least the fact that the forms were so provided;
providing to each said job candidate, by way of said network, an invitation to an interview, specifying the time and location for said interview, and entering into said single electronic docket at least information identifying said time and location of said interview;
substantially simultaneously with said provision of said invitation, and by way of said network, advising a selected hiring manager of the scheduling of said interview, and providing access by way of said network to said single electronic docket associated with said job candidate who is to be interviewed;
conducting an interview between said selected hiring manager and said job candidate, and entering a hiring assessment into said single electronic docket;
substantially simultaneously with, but after, said interview, reviewing the contents of said single electronic docket, making a decision as to whether to make an offer to said job candidate, and entering said decision into said single electronic docket.

2. A method according to claim 1, further comprising the step, substantially simultaneously with said interview, and by way of said network, of performing an assessment of at least one of security and compensation based upon the information in said single electronic docket, and entering the result of said assessment into said single electronic docket.

3. A method according to claim 1, further comprising the step, if said decision is affirmative, of electronically generating a hard-copy paper offer for transmission to said job applicant.

4. A method according to claim 1, wherein said step of electronically generating a hard-copy paper offer is performed substantially simultaneously with the step of transmitting information relating to said offer by way of said network to said job applicant.

5. A method according to claim 1, wherein said step of providing each said putative job candidate, by way, of a network, with access to electronic job application forms, further comprises the step of providing said putative job candidate with a code which allows access to said forms, and which allows said forms, when electronically filled out, to enter said single electronic docket.

6. A networked method for recruiting personnel for a business entity having a plurality of distinct business units, each having individual hiring requirements, in which at least some of said distinct business units compete for the same applicants, said method comprising the steps of:
correlating hiring needs from at least one of said distinct business units with information from resumes of job hunters to identify putative job candidates from whom a job application is desired;
setting up a single electronic docket for each said putative job candidate, and making said single electronic docket available on a network;
providing each said putative job candidate, by way of said network, with access to electronic job application forms, which when filled out and returned over said network by each said putative candidate becomes part of said single electronic docket of a job applicant, and entering into said single electronic docket of said job applicant information relating to at least the fact that the forms were so provided;
providing to each said job candidate, by way of said network, an invitation to an interview, specifying the time and location for said interview, and entering into said single electronic docket at least information identifying said time and location of said interview;
substantially simultaneously with said provision of said invitation, and by way of said network, advising a selected hiring manager of the scheduling of said interview, and providing access by way of said network to said single electronic docket associated with said job candidate who is to be interviewed;
conducting an interview between said selected hiring manager and said job candidate, and entering a hiring assessment into said single electronic docket;
substantially simultaneously with said interview, and by way of said network, performing an assessment of at least one of security and compensation based upon the information in said single electronic docket, and entering the result of said assessment into said single electronic docket;
substantially simultaneously with, but after, said interview, reviewing the contents of said single electronic docket, making a decision as to whether to make an offer to said job candidate, and entering said decision into said single electronic docket; and
if said decision is affirmative, electronically generating a hard-copy paper offer for transmission to said job applicant.

7. A method according to claim 6, wherein said step of electronically generating a hard-copy paper offer is performed substantially simultaneously with the step of transmitting information relating to said offer by way of said network to said job applicant.

8. A method according to claim 6, wherein said step of providing each said putative job candidate, by way of a network, with access to electronic job application forms, further comprises the step of providing said putative job candidate with a code which allows access to said forms, and which allows said forms, when electronically filled out, to enter said single electronic docket.
